(19) United States
(12) Patent Application Publication
(10) Pub. No.: US 2008/0302339 A1
(43) Pub. Date: Dec. 11, 2008

(54) Fuel Supply Device for a Motor Vehicle

(76) Inventors: Christian Krogull, Witten (DE); Knut Meyer, Essen (DE); Frank Reiter, Haan Rheinl (DE); Stefan Fuehling, Dortmund (DE); Helmut Kohlhaas, Wildeck (DE)

Correspondence Address: HANLEY, FLIGHT & ZIMMERMAN, LLC, 150 S. WACKER DRIVE, SUITE 2100, CHICAGO, IL, 60606, US

(21) Appl. No.: 11/587,365

(22) PCT Filed: Apr. 25, 2005
(86) PCT No.: PCT/EP05/51835

§ 371 Date: Oct. 24, 2006

(30) Foreign Application Priority Data
May 7, 2004 (DE) 10 2004 022 564.8

(51) Int. Cl. F02M 37/20

(52) U.S. Cl. 123/516; 137/87.01

(57) ABSTRACT

The invention relates to a fuel supply device (2) for a motor vehicle, which comprises a fuel tank (1). An intake connection (24) of a fuel pump (7) is located in a ventilation device (4). The fuel pump (7) simultaneously takes in fuel from the fuel tank (1) and from the ventilation device (4). For this purpose, the fuel pump (7) and a bubble removal container (8) of the ventilation device (4) are configured as a single structural unit.

### BACKGROUND OF THE INVENTION

The invention relates to a fuel supply device for a motor vehicle, comprising a fuel tank, a fuel pump drawing in fuel from the fuel tank and designed to deliver the fuel to an internal combustion engine of the motor vehicle, a venting device for balancing the fuel tank pressure with the ambient pressure when filling up or in operation, and a device for drawing off fuel from the venting device into the fuel tank.

Such fuel supply devices are commonly used in modern motor vehicles and are known in practice. In the known fuel supply device the fuel pump is fixed to the bottom of the fuel tank separately from the venting device and delivers fuel into a feed line leading to the internal combustion engine of the motor vehicle. From the feed line a line branches off to a suction jet pump arranged in the venting device. The suction jet pump delivers fuel from the venting device into the fuel tank. The components of the venting device are likewise fitted inside the fuel tank.

A disadvantage of the known fuel supply device is that the suction jet pump is very costly to fit in the venting device and requires a secondary flow of fuel delivered in the feed line as working fluid. When the venting device has been drained of fuel the suction jet pump draws in air, which leads to gassing in the fuel tank.

### BRIEF DESCRIPTION OF THE INVENTION

The object of the invention is to develop a fuel supply system of the aforementioned type so that it is particularly inexpensive to manufacture and gassing in the fuel tank is avoided.

According to the invention this object is achieved in that an intake connection of the fuel pump is connected to the venting device.

This configuration makes the fuel pump the device for drawing off fuel from the venting device. The provision of further pumps for drawing off fuel from the venting device is therefore avoided. As a result the fuel supply device according to the invention has exceptionally few components to be fitted and is thereby especially inexpensive to manufacture. A further advantage of the fuel supply system according to the invention is that the gassing generated by a suction jet pump is avoided when the venting device is drained of fuel. The fuel supply system according to the invention therefore leads to an especially low fuel vapor emission into the surroundings.

A reliable removal of fuel from the venting device is particularly inexpensive in terms of design construction in that the intake connection is connected to a bubble removal vessel designed to collect fuel accumulating in the venting device.

An intake of air by the fuel pump from the venting device already drained of fuel should be prevented. According to another advantageous development of the invention, a control for the intake connection opening into the venting device is of particularly simple design construction in that the intake connection connected to the venting device has a valve that closes when the venting device is empty. The valve is preferably actuated by a float. Alternatively the valve may also be electrically operated.

According to another advantageous development of the invention an expensive valve control of the intake connection connected to the venting device can be simply eliminated in that the intake connection connected to the venting device has a fine-mesh fabric filter, which is permeable only when covered by fuel and is impermeable to air. Such fine-mesh fabric filters are commonly used as main filter in the fuel feed units of modern motor vehicles. These fabric filters are generally composed of paper or fabric with very small openings. Fuel can pass through the openings. As soon as air reaches the fabric filter, however, cohesive and adhesive forces of the fuel prevent air passing through the openings. The fabric filter therefore prevents air getting into the intake connection connected to the venting device.

According to another advantageous development of the invention the design construction for removing fuel from the venting device is further simplified in that the fuel pump has two pump stages, a first pump stage for drawing in fuel being connected to the fuel tank and a second pump stage being connected to the intake connection connected to the venting device.

According to another advantageous development of the invention, lubrication of the fuel pump with fuel can be ensured at any time, even when the venting device is drained of fuel, in that the fuel pump takes the form of a side-channel pump and the pump stages have delivery chambers concentrically enclosing one another.

Where an intake of air from the venting device is prevented, the fuel supply device according to the invention can be of particularly simple design configuration in that the fuel pump has a single outlet intended to lead to the internal combustion engine. The fuel extracted from the venting device is thereby mixed with the fuel drawn in from the fuel tank and then fed to the internal combustion engine.

According to another advantageous development of the invention the risk of air drawn in from the venting device mixing with fuel to be delivered to the internal combustion engine is reliably prevented in that an outlet of the second pump stage opens into the fuel tank. The fuel pump thereby requires two outlets, one being led into the fuel tank and one to the internal combustion engine. This configuration means that an intake of air from the venting device does not lead to any gassing of the fuel fed to the internal combustion engine.

The assembly of the components of the fuel supply device according to the invention in the fuel tank is especially simplified in that the fuel pump and the venting device form a single module. A further advantage of this configuration is that the fuel pump can be tested together with the intake connection arranged in the venting device outside the fuel tank. This configuration is furthermore particularly advantageous in the case of a fuel tank produced by a blowing process, since the integration of the components of the single module to be fitted in the fuel tank greatly facilitates the assembly process. This furthermore serves to minimize the number of components of the fuel supply system, for example the fasteners and fixing flanges needed for fixing the venting device and the fuel pump in the fuel tank. This makes the fuel supply system according to the invention particularly inexpensive. This configuration is therefore inventive in itself.

According to another advantageous development of the invention, production of the single module comprising the venting device and the fuel pump is especially simplified in design terms in that the fuel pump is fixed to or in the bubble removal vessel of the venting device.

In order to further facilitate fitting of the components of the inventive fuel supply device in the fuel tank vent lines of the venting device are secured to the wall of the fuel tank.

In order to further reduce the costs of manufacturing the fuel supply device according to the invention an air outlet line of the venting device leading out of the fuel tank and a feed line led from the fuel pump to the internal combustion engine are led through a common sealing cap sealing off a fitting aperture of the fuel tank.

The venting device is generally arranged as high up inside the fuel tank as possible, in order to avoid any unnecessary contact with the fuel. Since according to the invention, however, the fuel is reliably drawn off from the venting device at any time, the fuel supply device according to the invention is of particularly simple configuration in that the single module comprising the venting device and the fuel pump is pre-tensioned against the bottom of the fuel tank. In this context venting lines are led into the upper area of the fuel tank and fixed there.

In modern motor vehicles the fuel pump is generally pre-tensioned against the bottom of the fuel tank, in order to ensure an unimpeded intake of fuel. In modern, generally very shallow fuel tanks the fuel supply device according to the invention can be of particularly simple configuration in that the single module comprising the venting device and the fuel pump is fixed to the sealing cap affixed to the top of the fuel tank. Here an intake line of the fuel pump is pre-tensioned against the bottom. This intake line preferably has a fine-mesh fabric filter, which is permeable only to fuel and which closes on contact with air. In this case a pressure filter, generally arranged downstream of the fuel pump in the direction of flow, can be of especially compact design or may even be omitted altogether.

### BRIEF DESCRIPTION OF THE DRAWINGS

The invention permits numerous embodiments. In order to further illustrate its basic principle, several such embodiments are represented in the drawing and are described below. In the drawing

FIG. 1 shows a schematic representation of a fuel tank having a fuel supply device according to the invention,

FIG. 2 shows a schematic representation of a further embodiment of the fuel supply device according to the invention,

FIG. 3 shows a partial section through a first embodiment of a fuel pump of the fuel supply device according to the invention,

FIG. 4 shows a partial section through a first embodiment of a fuel pump of the fuel supply device according to the invention,

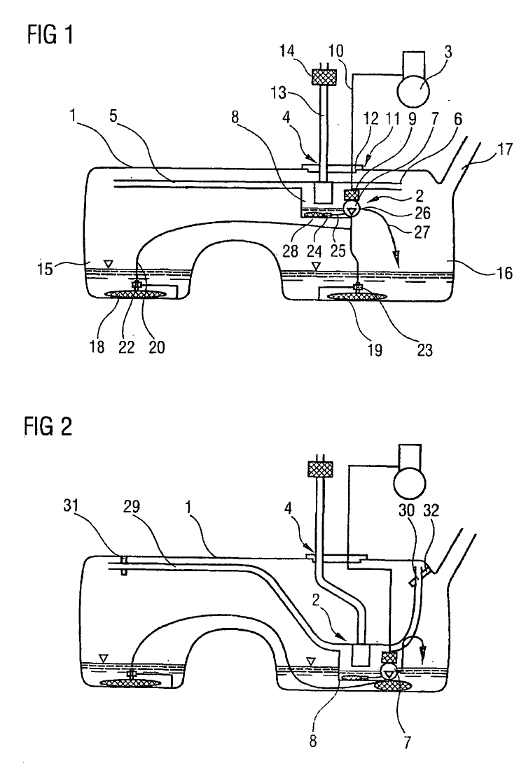

FIG. 1 shows a schematic, sectional representation of a fuel tank 1 having a fuel supply device 2 for supplying an internal combustion engine 3 of a motor vehicle with fuel. A venting device 4 with a plurality of vent lines 5, 6 and a fuel pump 7 are arranged inside the fuel tank 1. The fuel pump 7 forms one single module with a bubble removal vessel 8 of the venting device 4. A feed line 10 leading from the fuel pump 7 via a filter 9 to the internal combustion engine 3 is led through a sealing cap 12 fixed in a fitting aperture 11 of the fuel tank 1.

The venting device 4 is connected by an air outlet line 13 to an activated charcoal filter 14 arranged outside the fuel tank 1. The air outlet line 13 is also led through the sealing cap 12. By way of the venting device 4 the activated charcoal filter 14 establishes a pressure balance between the fuel tank 1 and the surroundings. The bubble removal vessel 8 collects fuel present in the venting device 4. The vent lines 5, 6 of the venting device 4 are of rigid design and protrude from the bubble removal vessel 8. The bubble removal vessel 8 is formed as a single module together with the fuel pump 7 and is fixed to the sealing cap 12.

The fuel tank 1 takes the form of a saddle tank having two chambers 15, 16 and has a filler neck 17 opening into one of the chambers 16. The fuel pump 7 draws fuel from both chambers 15, 16 via a pre-filter 18, 19 respectively. Lines 20, 21 leading from the pre-filters 18, 19 to the fuel pump 7 are connected together and are secured to the bottom of the fuel tank 1 by retainers 22, 23. The fuel pump 7 furthermore has a line 25 leading to an intake connection 24 arranged in the bubble removal vessel 8. The intake connection 24 has a pre-filter 28. The fuel pump 7 thereby also draws fuel from the bubble removal vessel 8. The fuel pump 7 furthermore has a shut-off connection 26 for the connection of a line 27 leading into the fuel tank 1. By way of this line 27 excess fuel can be returned to the fuel tank 1. In an alternative embodiment (not shown) the lines 20, 21 led into the chambers 15, 16 of the fuel tank l can be pre-tensioned against the bottoms of the chambers 15, 16. For this purpose the lines 20, 21 may themselves be sprung, for example, or they may be provided with pre-tensioning means (not shown) which pre-tension the ends of the lines 20, 21 remote from the fuel pump 7 away from the bubble removal vessel 8 against the bottoms of the chambers 15, 16.

The pre-filters 18, 19, 28 of the lines 20, 21, 25 connected to the fuel pump 7 are made of a fine-mesh fabric, which in its material and its mesh width is designed in such a way that when wet it is permeable only to fuel and is impermeable to air. The fuel pump 7 is therefore capable of drawing fuel as long as a single pre-filter 18, 19, 28 is covered by fuel.

Alternatively, valves may be arranged in each of the lines 20, 21, 25, which seal off the respective line 20, 21, 25 when there is no fuel present at the pre-filter 18, 19, 28. The lines 20, 21 leading into the chambers 15, 16 can furthermore also open into a commonly known swirl pot, so that fuel will be drawn from the latter.

FIG. 2 shows a further embodiment of the fuel supply device 2, which differs from that in FIG. 1 primarily in that the single module comprising the fuel pump 7 and the bubble removal vessel 8 is pre-tensioned against the bottom of the fuel tank 1. Vent lines 29, 30 of the venting device 4 are of flexible design and are connected to the upper wall of the fuel tank 1 by means of retaining elements 31, 32. Otherwise this fuel supply device 2 is constructed as described in relation to FIG. 1.

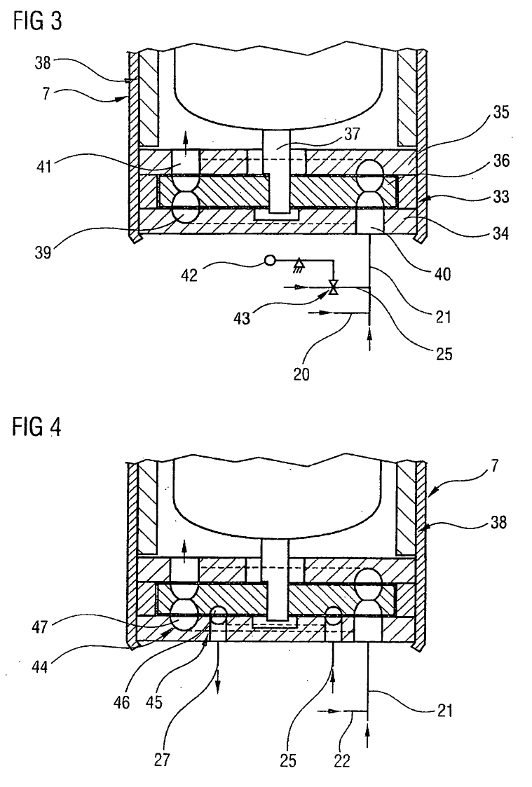

FIG. 3 shows a section through a first embodiment of the fuel pump 7 of the fuel supply device 2 in FIG. 1 or 2. The fuel pump 7 has a pump stage 33 in the form of a side-channel pump with an impeller 36 driven between two housing parts 34, 35. The impeller 36 is fixed on a shaft 37 of an electric motor 38. A delivery chamber 39 of the pump stage 33 is led from an inlet duct 40 arranged in one of the housing parts 34 through the impeller 36 to an outlet duct 41 arranged in the other housing part 35. Fuel delivered by the fuel pump 7 flows through the electric motor 38 and is delivered into the feed line 10 represented in FIGS. 1 and 2. Lines 20, 21 leading into the chambers 15, 16 and the line 25 leading to the intake connection 24 in the bubble removal vessel 8 are connected to the inlet duct 40. The line 25 led to the intake connection 24 in the bubble removal vessel 8 moreover has a valve 43, which is operated by a float 42 and which closes the line 25 when the fuel filling level in the bubble removal vessel 8 falls below a predetermined value. The valve 43 may obviously also be electrically operated. The valve 43 in the line 25 can also be dispensed with in that, through a corresponding mesh width, the pre-filter 28 in the bubble removal vessel 8 prevents air being drawn out of the venting device 4.

FIG. 4 shows a further embodiment of the fuel pump 7 of the fuel supply system in FIG. 1 or 2, which differs from that in FIG. 3 in that two pump stages 44, 45 are provided, one of the pump stages 44 delivering fuel from the chambers 15, 16 of the fuel tank 1 represented in FIGS. 1 and 2 through the electric motor 38 into the feed line 10 and the second pump stage 45 delivering fuel from the intake connection 24 in the bubble removal vessel 7 to the line 27 returned into the fuel tank 1. The delivery chambers 46, 47 of the pump stages 44, 45 enclose one another concentrically.

1. A fuel supply device for a motor vehicle, comprising a fuel tank, a fuel pump drawing in fuel from the fuel tank and designed to deliver the fuel to an internal combustion engine of the motor vehicle, a venting device for balancing the fuel tank pressure with the ambient pressure when filling up or ill operation, and a device for drawing off fuel from the venting device into the fuel tank, characterized in that an intake connection (24) of the fuel pump (7) is connected to the venting device (4).

2. The fuel supply device as claimed in claim 1, characterized in that the intake connection (24) is connected to a bubble removal vessel (8) designed to collect fuel accumulating in the venting device (4).

3. The fuel supply device as claimed in claim 1 or 2, characterized in that the intake connection (24) connected to the venting device (4) has a valve (43) that closes when the venting device (4) is empty.

4. The fuel supply device as defined in claim 1, characterized in that the intake connection (24) connected to the venting device (4) has a fine-mesh fabric filter, which is permeable only when covered by fuel and is impermeable to air.

5. The fuel supply device as defined in claim 1, characterized in that the fuel pump (7) has two pump stages (44, 45), a first pump stage (44) for drawing in fuel being connected to the fuel tank (1) and a second pump stage (45) being connected to the intake connection (24) connected to the venting device (4).

6. The fuel supply device as defined in claim 5, characterized in that the fuel pump (7) takes the form of a side-channel pump and the pump stages (44, 45) have delivery chambers (46, 47) concentrically enclosing one another.

7. The fuel supply device as defined in claim 1, characterized in that the fuel pump (7) has a single outlet intended to lead to the internal combustion engine (3).

8. The fuel supply device as defined in claim 7, characterized in that an outlet of the second pump stage (25) opens into the fuel tank (1).

9. The fuel supply device as defined in claim 1, characterized in that the fuel pump (7) and the venting device (4) form a single module.

10. The fuel supply device as defined in claim 1, characterized in that the fuel pump (7) is fixed to or in the bubble removal vessel (8) of the venting device (4).

11. The fuel supply device as defined in claim 1, characterized in that vent lines (5, 6, 29, 30) of the venting device (4) are secured to the wall of the fuel tank (1).

12. The fuel supply device as defined in claim 1, characterized in that an air outlet line (13) of the venting device (4) leading out of the fuel tank (1) and a feed line (10) led from the fuel pump (7) to the internal combustion engine (3) are led through a common sealing cap (12) sealing off a fitting aperture (11) of the fuel tank (1).

13. The fuel supply device as defined in claim 1, characterized in that the single module comprising the venting device (4) and the fuel pump (7) is pre-tensioned against the bottom of the fuel tank.

14. The fuel supply device as defined in claim 1, characterized in that the single module comprising the venting device (4) and the fuel pump (7) is fixed to the sealing cap (12) affixed to the top of the fuel tank (1).
